(19) United States
(12) Patent Application Publication
(10) Pub. No.: US 2020/0253239 A1
(43) Pub. Date: Aug. 13, 2020

(54) PROTEIN-DENSE NUTRITIONAL COMPOSITIONS FOR USE IN TREATING AND/OR PREVENTING A CONDITION LINKED TO LOSS OF MUSCLE MASS AND/OR STRENGTH

(71) Applicant: FrieslandCampina Nederland B.V., Amersfoort (NL)

(72) Inventors: Pauline Elisabeth Antoinette SMULDERS, Wageningen (NL); Renate Antonia GANZEVLES, Wageningen (NL); George VERLAAN, Wageningen (NL); Marieke Henriëtte SCHOEMAKER, Wageningen (NL)

(21) Appl. No.: 16/862,133

(22) Filed: Apr. 29, 2020

Related U.S. Application Data
(63) Continuation of application No. PCT/EP2018/079633, filed on Oct. 30, 2018.

(30) Foreign Application Priority Data
Oct. 30, 2017 (EP) 17199172.2

(51) Int. Cl. A23J 3/10; A23L 33/00; A23L 33/19; A23L 33/15; A23L 33/29; A23J 3/14; A23L 29/00

(52) U.S. Cl. CPC A23J 3/10; A23L 33/30; A23L 33/19; A23L 29/035; A23L 33/29; A23J 3/14; A23L 33/15

(57) ABSTRACT

The invention relates to the field of protein-dense liquid nutritional compositions for use in the treatment and/or prevention of a condition linked to loss of muscle mass and/or strength. Provided is a heat-treated liquid high-protein composition comprising at least 10 g of protein per 100 ml of the composition, wherein at least 40 wt. % of the protein is micellar casein and at least 10 wt. % of the protein is hydrolysed whey protein having a degree of hydrolysation of at least 5%, and wherein the weight ratio of micellar casein to hydrolysed whey protein is in the range of 40:60 to 90:10, for use in any one or more of the following:
a) preventing or reducing coagulation in the upper gastro-intestinal tract;
b) increasing the rate of gastric emptying;
c) enhancing protein digestion;
d) increasing the blood serum concentration of free essential amino acids, preferably leucine, in a subject.

### CROSS-REFERENCE TO RELATED APPLICATIONS

This application is a continuation of International Application No. PCT/EP2018/079633 filed Oct. 30, 2018, which claims the benefit of and priority to European Application No. 17199172.2 filed Oct. 30, 2017, both of which are hereby incorporated by reference herein in their entireties.

### TECHNICAL FIELD OF THE INVENTION

The invention relates to the field of protein-dense liquid nutritional compositions. Among others, it relates to compositions for use in the treatment and/or prevention of a condition linked to loss of muscle mass and/or strength, in particular a condition involving malnutrition and loss of muscle mass.

### BACKGROUND OF THE INVENTION

The loss of muscle mass and muscle strength considerably decreases the mobility and quality of life of elderly and patients since they lose the capacity to perform activities of daily living. Furthermore, loss of muscle impairs the recovery, leads to more complications, infections, longer hospital stay and even mortality. The reduced reserve capacity, leading to an increased risk for disability and other negative health outcomes, has been defined as frailty. When the muscle mass, strength and physical performance are below critical, clinical levels, it is called sarcopenia. This decline in muscle mass and strength can be a gradual decline due to aging and/or sedentary lifestyle or due to catabolic crises such as trauma, infections, disease, hospitalisation, and immobilisation.

Malnutrition, either undernutrition (protein-energy malnutrition, quantitative malnutrition) or qualitative malnutrition (selective for certain ingredients such as protein) strongly contributes to the development of loss of muscle mass (or muscle decline, atrophy), sarcopenia and frailty. Several common diseases, including cancer, AIDS, congestive heart failure, chronic obstructive pulmonary disease and others can lead to accelerated muscle loss (or atrophy), and even muscle wasting, cachexia.

Loss of muscle mass occurs by a change in the normal balance between protein synthesis and protein degradation. The provision of sufficient essential amino acids can be helpful in regenerating muscle tissue, since the essential amino acids including leucine, can contribute to muscle synthesis and muscle mass preservation. Thereby, nutrition leading to a sustained hyper-aminoacidemia, i.e. an elevated concentration of amino acids in the plasma, especially the essential amino acids including leucine, is essential in stimulating muscle protein synthesis of a sarcopenic, frail and/or malnourished older adult or patient in need.

Although each muscle wasting situation is characterized by its specific mechanism(s) and pathways leading to muscle loss, an increase of catabolic factors such as glucocorticoids, cytokines, and oxidative stress, often occurs. It is now well established that these factors have potential deleterious effects on the amino acids or insulin signaling pathways involved in the stimulation of muscle anabolism after food intake. These signaling alterations lead to an “anabolic resistance” of muscle even if the anabolic factor requirements (amino acids e.g.) are theoretically covered, that is, with a normal nutrient availability fitting the recommended dietary protein allowances in healthy subjects. See for a review on the anabolic threshold concept Dardavet et al. (The Scientific World Journal Volume 2012, 269531 (2012)), wherein it is described that anabolic resistance may be in part explained by an increase of the muscle “anabolic threshold” required to promote maximal anabolism and protein retention. Because the muscle “anabolic threshold” is higher, the anabolic stimuli (including aminoacidemia) cannot reach the anabolic threshold anymore and by consequence, muscle anabolism is reduced with the usual nutrient intake. A possible nutritional strategy is then to increase the intake of anabolic factors (especially essential amino acids including leucine) to reach the new “anabolic threshold”.

Aging is associated with impaired activation of postprandial muscle protein synthesis due to essential amino acids and leucine signaling defects. As such, the so-called anabolic threshold is higher. In other words, compared to a young person, the “leucine threshold” needed to start protein synthesis is higher in case of older adults and patients. Stimulation of muscle protein synthesis in such a case would require ingestion of a protein that enables to reach the increased anabolic threshold of plasma leucine levels (Phillips SM (2017) Front. Nutr. 4:13).

There are several ways to increase amino acid availability to skeletal muscle: increase protein intake, to supplement the diet with one or several free amino acids or to select the protein source on its amino acid composition and physicochemical properties when digested in the digestive tract.

It is known in the art that whey protein is leucine-rich (˜12 gram/100 gr protein), and therefore preferred protein source for increasing the concentration of essential amino acids in the blood. In accordance with this, WO2011/112695 lists a number of health benefits of whey proteins, among them enhancement of muscle development and building, as well as muscle maintenance in children, adults or elderly people. US2011/250310 also discloses that a whey composition combined with active ingredients, such as vitamin D, can help to improve muscular-skeletal health in elderly persons.

However, due to heat stability issues at high concentration, the use of whey protein as a source of protein is not feasible for small serving volumes that are typically the preferred choice for older and/or malnourished patients and frail elderly e.g. as liquid sip applications.

This problem was addressed among others in EP2249666, relating to shelf-stable (UHT) liquid enteral compositions with an increased amount of protein per unit volume (11-18 g/100 ml) while providing a sufficiently low viscosity to allow the composition to be easily consumed orally or by tube feeding. According to EP2249666, this was achieved by providing a composition comprising micellar casein and caseinate, in which 70-90 wt % of said protein is micellar casein, and wherein the combined amount of micellar casein and caseinate is at least 95 weight % of the total protein and said protein comprises less than or equal to 5 wt % of whey protein, said composition comprising 70-90 wt % micellar casein, based on total protein at least 95 weight % casein and caseinate, based on total protein and less than or equal to 5 wt % of whey protein based on total protein being subjected to heat-sterilization.

However, it was observed by the present inventors that the protein-dense, low viscosity compositions according to EP2249666 suffer from the drawback that it forms protein coagulates at stomach pH values and thus shows a reduced digestibility. As a consequence, they have a limited use for enhancing the concentration of essential amino acids in the blood, e.g. in the treatment and/or prevention of a condition linked to a loss of muscle mass and/or strength.

It is therefore an object of the present invention to develop an improved low volume liquid nutritional composition of low viscosity, having a high protein content (>10 g/100 ml), which is shelf-stable (UHT treated) and which does not suffer from coagulation in the upper gastro-intestinal tract. In particular, the inventors sought to provide a protein-dense liquid composition which is useful in the therapeutic or preventive treatment of loss of muscle mass and/or strength, for example a condition related to malnutrition and loss of muscle mass. Advantageously, the composition can be used to prevent or reduce coagulation in the upper gastro-intestinal tract; to increase the rate of gastric emptying; to enhance protein digestion, and/or to increasing the blood serum concentration of free essential amino acids, preferably leucine. Preferably, the composition shows a rate of gastric emptying, gastric digestion at substantially the same level as whey protein.

### SUMMARY OF THE INVENTION

It was surprisingly found that at least some of these goals were met by the provision of a heat-treated liquid high-protein composition comprising at least 10 g of protein per 100 ml of the composition, wherein at least 40 wt. % of the protein is micellar casein and at least 10 wt. % of the protein is hydrolysed whey protein having a degree of hydrolysation (DH) of at least 5%, and wherein the weight ratio of micellar casein to hydrolysed whey protein is in the range of 40:60 to 90:10. More in particular, it is demonstrated herein using a gastric simulation model that such a combination of micellar casein and hydrolysed whey protein allows gastric emptying and digestion comparable to whey protein, but considerably faster than the reference micellar casein and caseinate source as taught in EP2249666. Overall, the blend of micellar casein and hydrolysed whey allows for a high concentration (>10 g/100 ml) of high-quality protein (in contrast to e.g. hydrolysed collagen) in a small serving volume, and showing a fast and high-quality amino acid profile that is known to be beneficial in the treatment and/or prevention of a condition linked to a loss of muscle mass and/or strength.

Accordingly, in one aspect the invention provides a heat-treated liquid nutritional composition comprising at least 10 g of protein per 100 ml of the composition, wherein at least 40 wt. % of the protein is micellar casein and at least 10 wt. % of the protein is hydrolysed whey protein having a DH of at least 5%, and wherein the weight ratio of micellar casein to hydrolysed whey protein is in the range of 40:60 to 90:10, for use in the treatment and/or prevention of a condition linked to a loss of muscle mass and/or strength.

More in particular, the invention provides a heat-treated liquid nutritional composition comprising at least 10 g of protein per 100 ml of the composition, wherein at least 40 wt. % of the protein is micellar casein and at least 10 wt. % of the protein is hydrolysed whey protein having a DH of at least 5%, and wherein the weight ratio of micellar casein to hydrolysed whey protein is in the range of 40:60 to 90:10, for use in the treatment and/or prevention of a condition linked to a loss of muscle mass and/or strength in a subject, wherein the subject is in a disease state, recovering from a disease state, and/or malnourished. In particular, the subject suffers from a decline of lean muscle mass, muscle wasting, muscle decline, bone decline, sarcopenia, osteoporosis and/or osteosarcopenia, more in particular from a decline of lean muscle mass, muscle wasting, muscle decline and/or sarcopenia.

In another aspect, the invention relates to a heat-treated liquid nutritional composition comprising at least 10 g of protein per 100 ml of the composition, wherein at least 40 wt. % of the protein is micellar casein and at least 10 wt. % of the protein is hydrolysed whey protein having a DH of at least 5%, and wherein the weight ratio of micellar casein to hydrolysed whey protein is in the range of 40:60 to 90:10, for use in any one or more of the following: a) preventing or reducing coagulation in the upper gastro-intestinal tract; b) increasing the rate of gastric emptying; c) enhancing protein digestion; d) increasing the blood serum concentration of free essential amino acids, preferably leucine, in a subject. In particular, the subject is in a disease state, recovering from a disease state, and/or malnourished. More in particular, the subject suffers from a decline of lean muscle mass, muscle wasting, muscle decline, bone decline, sarcopenia, osteoporosis and/or osteosarcopenia, preferably from a decline of lean muscle mass, muscle wasting, muscle decline and/or sarcopenia.

The invention also relates to the use of a composition as herein disclosed, for any one or more of the following: a) preventing or reducing coagulation in the upper gastro-intestinal tract; b) increasing the rate of gastric emptying; c) enhancing protein digestion; d) increasing the blood serum concentration of free essential amino acids, preferably leucine; in a subject. Typically, these latter uses are not for the purpose of carrying out therapy on the human or animal body. Thus, the invention relates to a non-therapeutic method for any one or more of the following: a) preventing or reducing coagulation in the upper gastro-intestinal tract; b) increasing the rate of gastric emptying; c) enhancing protein digestion; d) increasing the blood serum concentration of free essential amino acids, preferably leucine; in a subject, comprising the step of administering to the subject a heat-treated liquid high-protein composition comprising at least 10 g of protein per 100 ml of the composition, wherein at least 40 wt. % of the protein is micellar casein and at least 10 wt. % of the protein is hydrolysed whey protein having a degree of hydrolysation of at least 5%, and wherein the weight ratio of micellar casein to hydrolysed whey protein is in the range of 40:60 to 90:10.

In still another embodiment, the invention relates to a composition as herein disclosed for use in a method for increasing the blood serum concentration of essential amino acids to overcome anabolic resistance in a subject, preferably an older subject, a subject in a diseased state, a subject that is recovering from a disease state, or a subject that is malnourished.

A composition for use or a method according to the present invention is not disclosed or suggested in the art.

WO2013/133727 relates to casein compositions for increasing the rate of gastric emptying following ingestion of the composition. It is disclosed that casein being about 10 to about 100% calcium depleted, having a degree of hydrolysis less than about 1% and having an unmodified phosphorylation pattern, is able to increase the blood serum concentration of free leucine in a subject to substantially the same level as whey protein within about 15 to about 60 minutes of administration. WO2013/133727 teaches against the use of micellar casein, let alone micellar casein in combination with hydrolysed whey. Furthermore, at very high protein concentrations, the compositions of WO2013/133727 will be too viscous after heat treatment.

WO2016/174651 relates to liquid high-protein compositions comprising a combination of micellar casein and hydrolysed whey protein and methods for preparing the same. It generally teaches various nutritional uses thereof. Importantly however, it does not address the digestibility/coagulation properties and it fails to teach or suggest the uses of the present invention relating to the treatment and/or prevention of a condition linked to a loss of muscle mass and/or strength.

The invention also relates to a heat-treated liquid high-protein composition, wherein at least 40 wt. % of the protein is micellar casein and at least 10 wt. % of the protein is hydrolysed whey protein, wherein the ratio of micellar casein to hydrolysed whey protein is in the range of 40:60 to 90:10, and wherein the composition is in the form of a unit serving size of up to 100 ml, preferably up to 80 ml, and wherein said unit serving size comprises at least 15 g of protein, preferably at least 18 g of protein.

### DETAILED DESCRIPTION OF THE INVENTION

The verb “to comprise” as is used in this description and in the claims and its conjugations is used in its non-limiting sense to mean that items following the word are included, but items not specifically mentioned are not excluded.

In addition, reference to an element by the indefinite article “a” or “an” does not exclude the possibility that more than one of the element is present, unless the context clearly requires that there is one and only one of the elements. The indefinite article “a” or “an” thus usually means “at least one”.

The term “about” is used herein to indicate that a certain deviation from a cited value is allowed. The magnitude of this deviation, depending amongst others on the accuracy of the method to determine the cited value, is generally in the range of ±10%, more in particular in the range of ±5%, of the cited value.

The term “nutritional composition” as used herein refers to a nutritional composition comprising one or more of protein, carbohydrate and fat. The nutritional composition may comprise further components, e.g. vitamins and minerals. The nutritional composition may be formulated as a complete nutrition, and potentially serve as the sole source of nutrition. Alternatively, the nutritional composition may be in the form of a food supplement.

The term “enteral nutritional composition” herein refers to a nutritional composition that may be administered to a person enterally, i.e. orally or by tube. Examples of an enteral nutritional composition include a sip feed and a tube feed.

The term “heat-treated nutritional composition” herein refers to a nutritional composition that has undergone a heat-treatment. The term “heat-treatment” herein refers to a treatment at an elevated temperature, aimed at increasing the shelf-life of said nutritional composition. Examples of a heat-treatment include sterilization and UHT (ultra-heat-treatment or ultra-high-temperature processing).

The term “shelf-stable” herein refers to storage stability. A nutritional composition is shelf-stable if it is storage stable at ambient temperature with respect to microbiological spoilage and physical defects like creaming, gelation, precipitation, etc., for a certain amount of time. Preferably, a nutritional composition has a shelf-stability of at least one month, more preferably at least 3 months, even more preferably at least 6 months and most preferably at least 12 months after packaging, when stored in a sealed packaging at ambient temperature (20° C.).

### Liquid Nutritional Composition

The present invention relates to specific uses of a liquid nutritional composition comprising at least 10 g of protein per 100 ml of the composition, wherein at least 40 wt. % of the protein is micellar casein and at least 10 wt. % of the protein is hydrolysed whey protein having a degree of hydrolysation of at least 5%, and wherein the ratio of micellar casein to hydrolysed whey protein is in the range of 40:60 to 90:10.

The nutritional composition for use according to the invention, or the nutritional composition used in the methods according to the invention, may be formulated as a complete nutrition, and potentially serve as the sole source of nutrition for a person in need thereof. Alternatively, the nutritional composition may be in the form of a food supplement.

In a preferred embodiment, the nutritional composition for use according to the invention, or the nutritional composition used in the methods according to the invention, has an energy density of 1.5 kcal/ml or higher (6.28 kJ/ml or higher), more preferably of 2.0 kcal/ml or higher (8.37 kJ/ml or higher), even more preferably of 2.5 kcal/ml or higher (10.46 kJ/ml or higher). It is further preferred that the energy density of the nutritional composition is 3.5 kcal/ml or higher (14.64 kJ/ml or higher), for example for application in undernourished, malnourished patients and frail older adults.

In a preferred embodiment, the composition is formulated to provide a subject with a high dose of easily digestible protein in a small unit serving size, and advantageously has the form of a sip drink or “protein shot”. For example, the liquid nutritional composition has a unit serving size comprising at least 12 g of protein, preferably at least 15 g of protein, more preferably at least 18 g of protein and/or wherein the liquid nutritional composition has a unit serving volume of up to 125 ml, preferably up to 100 ml, more preferably up to 80 ml. These compositions are advantageously used to supplement the diet of (qualitatively) malnourished patients and sarcopenic and/or frail older adults and/or older adults at risk for muscle loss.

In one embodiment, the unit serving size comprises at least 12 g of protein, preferably at least 15 g of protein, more preferably at least 18 g of protein and has a unit serving volume of up to 125 ml.

In another embodiment, the unit serving size comprises at least 12 g of protein, preferably at least 15 g of protein, more preferably at least 18 g of protein and has a unit serving volume of up to 100 ml.

In yet another embodiment, the unit serving size comprises at least 12 g of protein, preferably at least 15 g of protein, more preferably at least 18 g of protein and has a unit serving volume of up to 80 ml.

The invention therefore also provides a heat-treated liquid high-protein composition, wherein at least 40 wt. % of the protein is micellar casein and at least 10 wt. % of the protein is hydrolysed whey protein, wherein the ratio of micellar casein to hydrolysed whey protein is in the range of 40:60 to 90:10, and wherein the composition is in the form of a unit serving size of up to 100 ml, preferably up to 80 ml, and wherein said unit serving size comprises at least 15 g of protein, preferably at least 18 g of protein.

### Uses of the Composition

Based on the unique and beneficial properties relating to gastric emptying and digestibility of a composition comprising a blend of micellar casein and hydrolysed whey as herein disclosed, a person skilled in the art will recognize and appreciate the wide variety of possible (therapeutic) uses thereof.

In one aspect, the invention provides a composition for use in the treatment and/or prevention of a condition linked to a loss of muscle mass and/or strength. This method may be of therapeutic or non-therapeutic use of an intact human or animal.

Also provided is a composition for use in any one or more of the following:

a) preventing or reducing coagulation in the upper gastro-intestinal tract;

b) increasing the rate of gastric emptying;

c) enhancing protein digestion;

d) increasing the blood serum concentration of free essential amino acids, preferably leucine,

in a subject.

In another aspect, a non-therapeutic method is provided, for any one or more of the following:
a) preventing or reducing coagulation in the upper gastro-intestinal tract;
b) increasing the rate of gastric emptying;
c) enhancing protein digestion;
d) increasing the blood serum concentration of free essential amino acids, preferably leucine,
   in a subject, the method comprising the step of administering to the subject a heat-treated liquid high-protein composition comprising at least 10 g of protein per 100 ml of the composition, wherein at least 40 wt. % of the protein is micellar casein and at least 10 wt. % of the protein is hydrolysed whey protein having a degree of hydrolysation of at least 5%, and wherein the weight ratio of micellar casein to hydrolysed whey protein is in the range of 40:60 to 90:10.

Preferably, the composition is used for increasing the blood serum concentration of essential amino acids to overcome anabolic resistance in a subject. In one specific embodiment, the composition increases the blood serum concentration of leucine in a subject to higher than 250 micromol/L, preferably higher than 300 micromol/L within about 60 minutes after administration.

The subject may be an older subject (also referred to as an elderly subject) or a subject in a diseased state. In a preferred embodiment of the compositions for use according to the invention, and of the methods according to the invention, the subject is an elderly subject, preferably an aged subject having an age of 50 years or more. For example, a composition for use as herein disclosed is preferably administered or consumed by an aged subject having an age of 50 years or more.

In one embodiment of the composition for use according to the invention, or of the methods according to the invention, the subject is in a disease state, recovering from a disease state, and/or a subject that is malnourished.

For example, the subject, optionally an elderly subject, suffers from a decline of lean body mass, muscle wasting, muscle decline, bone decline, sarcopenia, osteoporosis and/or osteosarcopenia.

In particular, the invention thus provides a composition for use in the treatment and/or prevention of a condition linked to a loss of muscle mass and/or strength in a subject, wherein the subject is in a disease state, recovering from a disease state, and/or malnourished. More in particular, the subject suffers from a decline of lean muscle mass, muscle wasting, muscle decline, bone decline, sarcopenia, osteoporosis and/or osteosarcopenia, preferably from a decline of lean muscle mass, muscle wasting, muscle decline and/or sarcopenia.

The invention also provides a composition for use in any one or more of the following:

a) preventing or reducing coagulation in the upper gastro-intestinal tract;

b) increasing the rate of gastric emptying;

c) enhancing protein digestion;

d) increasing the blood serum concentration of free essential amino acids, preferably leucine,

in a subject, wherein the subject is in a disease state, recovering from a disease state, and/or malnourished. More in particular, the subject suffers from a decline of lean muscle mass, muscle wasting, muscle decline, bone decline, sarcopenia, osteoporosis and/or osteosarcopenia, preferably from a decline of lean muscle mass, muscle wasting, muscle decline and/or sarcopenia.

The invention also relates to a therapeutic method for any one or more of the following:
a) preventing or reducing coagulation in the upper gastro-intestinal tract;
b) increasing the rate of gastric emptying;
c) enhancing protein digestion;
d) increasing the blood serum concentration of free essential amino acids, preferably leucine,
   in a subject, the method comprising the step of administering to the subject a heat-treated liquid high-protein composition comprising at least 10 g of protein per 100 ml of the composition, wherein at least 40 wt. % of the protein is micellar casein and at least 10 wt. % of the protein is hydrolysed whey protein having a degree of hydrolysation of at least 5%, and wherein the weight ratio of micellar casein to hydrolysed whey protein is in the range of 40:60 to 90:10. In particular, the subject is in a disease state, recovering from a disease state, and/or malnourished. More in particular, the subject suffers from a decline of lean muscle mass, muscle wasting, muscle decline, bone decline, sarcopenia, osteoporosis and/or osteosarcopenia, preferably from a decline of lean muscle mass, muscle wasting, muscle decline and/or sarcopenia.

Also provided is a therapeutic method for the treatment and/or prevention of a condition linked to a loss of muscle mass and/or strength in a subject, the method comprising the step of administering to the subject a heat-treated liquid high-protein composition comprising at least 10 g of protein per 100 ml of the composition, wherein at least 40 wt. % of the protein is micellar casein and at least 10 wt. % of the protein is hydrolysed whey protein having a degree of hydrolysation of at least 5%, and wherein the weight ratio of micellar casein to hydrolysed whey protein is in the range of 40:60 to 90:10.

In particular, the subject is in a disease state, recovering from a disease state, and/or malnourished. More in particular, the subject suffers from a decline of lean muscle mass, muscle wasting, muscle decline, bone decline, sarcopenia, osteoporosis and/or osteosarcopenia, preferably from a decline of lean muscle mass, muscle wasting, muscle decline and/or sarcopenia.

Muscle wasting refers to the progressive loss of muscle mass and/or to the progressive weakening and degeneration of muscles, including the skeletal or voluntary muscles, which control movement, cardiac muscles, which control the heart (cardiomyopathics), and smooth muscles. Chronic muscle wasting is a chronic condition (i.e. persisting over a long period of time) characterized by progressive loss of muscle mass, weakening and degeneration of muscle. Protein catabolism occurs because of an unusually high rate of protein degradation, an unusually low rate of protein synthesis, or a combination of both. Muscle protein catabolism, whether caused by a high degree of protein degradation or a low degree of protein synthesis, leads to a decrease in muscle mass and to muscle wasting.

Muscle wasting is associated with chronic, neurological, genetic or infectious pathologies, diseases, illnesses or conditions. These include muscular dystrophies such as Duchenne muscular dystrophy and myotonic dystrophy; muscle atrophies such as post-polio muscle atrophy (PPMA); muscle wasting conditions such as cardiac cachexia, AIDS cachexia and cancer cachexia, malnutrition, leprosy, diabetes, renal disease, chronic obstructive pulmonary disease (COPD), cancer, end stage renal failure, emphysema, osteomalacia, HIV Infection, AIDS, and cardiomyopathy.

In one specific embodiment, the subject is affected by a condition selected from the group consisting of age-associated wasting, wasting associated with long-term hospitalization, wasting associated with muscle disuse, wasting associated with muscle immobilization, wasting associated with chemotherapy or long-term steroid use, and combinations thereof.

In another specific embodiment, the invention provides a composition for use in the treatment or prevention of sarcopenia. Sarcopenia is the degenerative loss of skeletal muscle mass and strength associated with aging. This loss of muscle mass is a result of a drastic reduction of protein synthesis in skeletal muscles, which disrupts the normal equilibrium between protein synthesis and protein degradation required for maintaining muscle mass. Because many older adults face the problem of reduced dietary intake due to loss of appetite, sarcopenia can significantly impact the lives of older adults. Sarcopenia is known to be associated with Frailty Syndrome, which is a collection of markers or symptoms primarily due to the aging-related loss and dysfunction of skeletal muscle and bone. The loss of skeletal muscle due to sarcopenia may lead to a number of problems in older adults, including mobility and dexterity issues, and potentially hyperglycemia due to diminished capacity for glucose disposal and metabolism and insulin resistance. Although the described nutritional interventions should are preferably consumed after (resistance) exercise and as part of rehabilitation program, a composition disclosed in the present invention may be advantageously used to combat sarcopenia and its associated problems in older adults where exercise is not a viable alternative to properly combat sarcopenia.

According to the invention, a subject desirably consumes at least one serving unit of the protein-dense liquid nutritional composition daily, and in some embodiments, he or she may consume two, three, or even more servings per day. Each serving is desirably administered as a single, undivided dose (also referred herein as “serving unit”), although the serving may also be divided into two or more partial or divided servings to be taken at two or more times during the day. The uses of the present disclosure include continuous day-after-day administration, as well as periodic or limited administration, although continuous day-after-day administration is generally desirable. A composition for use of the present disclosure is preferably applied on at least a daily basis, wherein the daily administration is maintained continuously for at least 3 days, including at least 5 days, including at least 1 month, including at least 6 weeks, including at least 8 weeks, including at least 2 months, including at least 6 months, desirably for at least about 18-24 months, desirably as a long term, continuous, daily, dietary supplement.

### Protein

The protein-dense nutritional composition for use according to the invention, and the protein-dense nutritional composition used in the methods of the invention, comprises at least 10 g of protein per 100 ml of the composition. The total protein that is present in the nutritional composition, i.e. the combination of all proteins present, may also be referred to as the “protein fraction” of the nutritional composition. The nutritional composition thus comprises a protein fraction of 10 g or more per 100 ml of the composition. In a preferred embodiment the composition comprises a protein fraction of at least 11 g per 100 ml of the composition, more preferably of at least 12 g per 100 ml of the composition. Most preferably the composition comprises a protein fraction of at least 15 g, like 16 g or more, 17 g or more of protein per 100 ml of the composition. In a specific aspect, the composition comprises a 10-20 g protein per 100 ml of the composition, preferably 12-20 g, more preferably 15-20 g per 100 ml of the composition.

In one embodiment, the combined amount of micellar casein and hydrolysed whey protein is at least 70 wt %, preferably at least 75 weight %, of the total protein fraction of the nutritional composition. It is further preferred that the micellar casein and hydrolysed whey protein together constitute at least 85 wt. % of the protein, at least 85 wt. %, at least 90 wt. %, or up to 95 wt. %, based on total weight of protein.

In a protein-dense composition for use of according to the invention and in a protein-dense nutritional composition used in the methods of the invention, for example a protein dense medical nutrition product or protein shot, the protein fraction preferably provides at least 20% of the total energy content of the composition. For example, the protein fraction provides at least 25% or at least 30% of the total energy content of the composition. In one aspect, e.g. when the composition is a protein-shot or similar product, at least 50% or at least 60% of the energy content is provided by the protein fraction. In one embodiment, the protein fraction provides all or nearly all, i.e. up to 90%, up to 95%, up to 98%, or even 100%, of the total energy content of the composition. For example, the protein provides 60 to 100%, preferably 65 to 98%, 70 to 98%, 70 to 95%, of the total energy content of the composition.

Fresh milk contains about 2.6 g casein per 100 ml, and almost all casein is present in the form of casein micelles (Walstra et al., “Dairy Science and Technology”, 2nd Ed., CRC Press 2006). Micellar casein may also be referred to as native micellar casein. However, the nature of the micelles in micellar casein as comprised in fresh milk may alter during processing, without the casein actually losing its micellar structure. Within the context of this invention, the term “micellar casein” refers to native micellar casein as present in fresh milk, but also to micellar casein wherein the micellar structure and/or composition may differ from the micellar structure and/or composition as present in fresh milk. In contrast, casein that has lost its micellar structure, e.g. by acid precipitation, is herein referred to as “caseinate”.

Processes to concentrate micellar casein from milk, e.g. by filtration, are known in the art and several sources of micellar casein are commercially available. Micellar casein isolate (MCI) typically comprises about 80 wt. % or more of protein, based on dry matter. Based on protein dry matter, MCI typically comprises about 90 wt. % or more of micellar casein, preferably about 95 wt. %, the remaining part compromising whey proteins and non-protein nitrogen. In milk protein concentrate (MPC) and milk protein isolate (MPI) the about 80:20 natural ratio of micellar casein to whey is largely preserved. Typically, MPC comprises about 80 wt. % protein and MPI 85 wt. % or more, based on dry matter.

A particularly preferred source of micellar casein is MCI. MCI is, amongst others, commercially available from several suppliers, including FrieslandCampina DOMO (Amersfoort, the Netherlands).

As described above, at least 40 wt. % of the protein in the nutritional composition is micellar casein. In a preferred embodiment at least 45 wt. % of the protein is micellar casein, more preferably at least 50 wt. %, even more preferably at least 55 wt. %, and most preferably at least 60 wt. % of the protein. In other words, the protein fraction of the nutritional composition comprises 40 wt. % or more, based on the total weight of the protein fraction, of micellar casein, preferably 45 wt. % or more, more preferably 50 wt. % or more, even more preferably 55 wt. % or more, and most preferably 60 wt. % or more of micellar casein, based on the total weight of the protein fraction.

It is further preferred that 90 wt. % or less of the protein is micellar casein, more preferably 85 wt. % or less, for example 80 wt. % or less, 75 wt. % or less or 70 wt. % or less. In other words, it is preferred that the protein fraction of the nutritional composition comprises 90 wt. % or less, preferably 85 wt. % or less, for example 80 wt. % or less, 75 wt. % or less or 70 wt. % or less of micellar casein, based on the total weight of the protein fraction.

At least 10 wt. % of the protein in the nutritional composition according to the invention and in the nutritional composition used in the methods of the invention, is hydrolysed whey protein. Preferably, at least 15 wt. % and more preferably more than 15 wt. %, e.g. 15.5 or 16 wt. % of the protein is hydrolysed whey protein. In a further preferred embodiment at least 20 wt. %, more preferably at least 25 wt. % and most preferably at least 30 wt. % of the protein is hydrolysed whey protein. In other words, the protein fraction of the nutritional composition comprises 10 wt. % or more of hydrolysed whey protein, based on the total weight of the protein fraction, preferably 15 wt. % or more and more preferably more than 15 wt. %, e.g. 15.5 or 16 wt. % of hydrolysed whey protein, based on the total weight of the protein fraction. More preferably the protein fraction of the nutritional composition comprises 20 wt. % or more of hydrolysed whey protein, based on the total weight of the protein fraction, e.g. 25 wt. % or more or 30 wt. % or more. It is further preferred that 60 wt. % or less, preferably less than 50 wt. %, of the protein is hydrolysed whey protein, e.g. 45 wt. % or less or 40 wt. % or less.

The term “hydrolysed whey protein” herein refers to whey protein that has been processed and/or treated in a manner intended to break peptide bonds. The term “hydrolysed whey protein” thus refers to whey protein that is at least mildly hydrolysed. Intentional hydrolysis may be carried out by e.g. treating intact protein with one or more enzymes and/or with acids or bases.

A measure for the extent of hydrolysation of the whey protein is the “degree of hydrolysation” (DH). The degree of hydrolysation is defined as the percentage of the total number of peptide bonds in a protein that has been cleaved during hydrolysis. The degree of hydrolysis of a protein may e.g. be determined by the trinitrobenzenesulphonic acid (TNBS) procedure, as known in the art (Adler-Nissen, J. Agr. Food Chem. 1979, 27(6), 1256). When whey protein is subjected to a hydrolysis process, the source of whey protein may already comprise a certain (small) amount of peptide fractions, before being subjected to the hydrolysis process. The values for the degree of hydrolysation as described herein are corrected for this presence of peptide-fractions in the whey protein source, in other words, the values for the degree of hydrolysation are corrected for the natural degree of hydrolysation of whey protein. Herein, the degree of hydrolysation thus relates to the additional hydrolysation that was obtained via the intentional hydrolysis process.

The main proteins in whey protein are α-lactalbumin and β-lactoglobulin. Whey protein comprises about 18 wt. % α-lactalbumin and about 50 wt. % β-lactoglobulin, based on total protein. Additional proteins in whey protein include serum albumin and immunoglobulins. It is to be understood that the term hydrolysed whey protein as used herein also refers to whey protein wherein e.g. either the α-lactalbumin or the β-lactoglobulin is, at least partially, hydrolysed. Consequently, the hydrolysed whey protein may still comprise intact protein. As defined above, the term “hydrolysed whey protein” refers to whey protein that has been processed and/or treated in a manner intended to break peptide bonds. This definition includes a treatment of whey protein in a manner that is intended to break peptide bonds in one of the proteins constituting whey protein preferentially, leaving other proteins substantially intact. The term hydrolysed whey protein thus also refers to whey protein that has been treated in a manner intended to break peptide bonds in β-lactoglobulin, leaving α-lactalbumin wholly or partly intact, and to whey protein that has been treated in a manner intended to break peptide bonds in α-lactalbumin, leaving β-lactoglobulin wholly or partly intact.

In a nutritional composition for use according to the invention and in a nutritional composition used in the methods of the invention, the hydrolysed whey protein has a degree of hydrolysation of 5% or more. More preferably, the degree of hydrolysation is 5.5% or more, even more preferably 6% or more and yet even more preferably 7% or more. Most preferably the degree of hydrolysation is 8% or more. In this embodiment it is further preferred that the degree of hydrolysation is 40% or lower, preferably 35% or lower, more preferably 30% or lower and most preferably 25% or lower. It is preferred that the degree of hydrolysation of the whey protein is in the range of 5 to 25%, for example in the range of 7-15%. As described above, the degree of hydrolysation as used herein is corrected for the natural degree of hydrolysation of the whey protein source, i.e. the whey protein that was used for the preparation of the hydrolysed whey protein.

In another particular embodiment of the nutritional composition, the hydrolysed whey protein comprises 40 wt. % or less intact protein, preferably 30 wt. % or less intact protein, more preferably 20 wt. % or less intact protein, even more preferably 15 wt. % or less intact protein and yet even more preferably 10 wt. % or less intact protein, based on total protein in the hydrolysed whey protein.

Processes for the manufacturing of hydrolysed whey protein are known in the art. Hydrolysed whey protein may for example be prepared by subjecting whey protein concentrate (WPC), whey protein isolate (WPI), serum protein concentrate (SPC) or serum protein isolate (SPI) to an enzymatic hydrolysis process. Alternatively, hydrolysed whey protein may be prepared by acid or base hydrolysis of whey protein. WPC, WPI, SPC and SPI may be obtained by processes known in the art, such as the processing of sweet whey or acid whey, ultrafiltration or microfiltration processes.

Whey protein concentrate (WPC) typically comprises about 35 to about 80 wt. % protein, based on dry matter. Whey protein isolate (WPI) typically comprises about 85 wt. % or more protein, based on dry matter. Serum protein concentrate (SPC) typically comprises about 60 wt. % protein, based on dry matter. Serum protein isolate (SPI) typically comprises about 85 wt. % protein, based on dry matter.

Hydrolysed whey protein is commercially available from several suppliers. Examples of suitable sources of hydrolysed whey protein include products of the Hyvital hydrolysed whey protein range of FrieslandCampina Domo (Amersfoort, the Netherlands), e.g. Hyvital Whey ETD 100, Hyvital Whey ETD 110, Hyvital Whey ETD 120, Hyvital Whey 8016, Hyvital Whey 8022 and Hyvital Whey HA 300, and hydrolysed whey protein products available from, amongst others, Kerry (Ireland), Arla (Denmark) and Fonterra (New Zealand).

According to the invention, the ratio of micellar casein to hydrolysed whey protein in a composition for use or a composition used in a method disclosed herein is in the range of 40:60 to 90:10 by weight. In exemplary embodiments, the weight ratio of micellar casein to hydrolysed whey protein is for example in the range of 40:60 to 88:12, or 40:60 to 85:15, or 40:60 to 82:18, or 40:60 to 80:20, or 40:60 to 78:22, or 40:60 to 75:25 or 40:60 to 70:30. Preferably, the ratio of micellar casein to hydrolysed whey protein is in the range of 54:46 to 90:10, more preferably in the range of 56:44 to 90:10, even more preferably in the range of 48:52 to 90:10. In this embodiment it is further preferred that the ratio of micellar casein to hydrolysed whey protein is in the range of 40:60 to 80:20, for example in the range of 54:46 to 80:20, more preferably in the range of 56:44 to 80:20, even more preferably in the range of 48:52 to 80:20. Very good results can be obtained if the ratio of micellar casein to hydrolysed whey protein is in the range of 58:42 to 77:23, for example in the range of 58:42 to 75:25, more preferably in the range of 60:40 to 75:25, even more preferably in the range of 60:40 to 70:30.

In addition to micellar casein, whey protein and hydrolysed whey protein, the protein fraction may comprise one or more additional proteins. The additional protein may e.g. be selected from the group consisting of intact or hydrolysed caseinate, intact or hydrolysed plant protein, intact or hydrolysed algal protein and hydrolysed collagen.

The term caseinate herein refers to casein that has lost its micellar structure. Preferably the caseinate, if present, is selected from the group consisting of sodium caseinate, calcium caseinate, potassium caseinate and magnesium caseinate, more preferably from the group consisting of calcium caseinate, potassium caseinate and sodium caseinate.

Plant proteins may be grouped by their origin, and include proteins originating from oil seeds, tuber, pulses, cereals, maize, green leaf vegetables, legumes, etc. Examples of oil seed protein include soy protein, canola protein, rapeseed protein, etc. Examples of cereal protein include wheat protein, rice protein and quinoa protein. An example of a pulse seed protein is pea protein, and an example of a tuber (potato) protein is patatin. Examples of green leaf vegetable protein include protein derived from spinach, kale, etc. The term hydrolysed collagen herein also refers to hydrolysed gelatin.

The one or more additional proteins, if present, may be selected from the group consisting of intact or hydrolysed caseinate, intact or hydrolysed plant protein, intact or hydrolysed algal protein and hydrolysed collagen. For example, the one or more additional proteins, if present, are selected from the group consisting of intact or hydrolysed sodium caseinate, calcium caseinate, potassium caseinate, magnesium caseinate, soy protein, canola protein, rapeseed protein, wheat protein, rice protein, quinoa protein, pea protein, maize protein, hydrolysed collagen and hydrolysed gelatin. In one aspect, the casein in a composition for use, and in a composition used in the methods, according to the invention is only present in the form of micellar casein. Hence, in one embodiment the composition does not comprise intact or hydrolysed calcium caseinate, potassium caseinate, sodium caseinate and/or magnesium caseinate.

The one or more additional proteins, if present, constitute 50 wt. % or less of the protein, preferably less than 50 wt. %, based on total weight of protein in the nutritional composition. It is further preferred that the one or more additional proteins constitute 45 wt. % or less of the protein, more preferably 40 wt. % or less, 35 wt. % or less, 30 wt. % or less, 25 wt. % or less, 20 wt. % or less, 15 wt. % or less, 10 wt. % or less or 5 wt. % or less, based on total weight of protein in the nutritional composition.

In an alternative specific embodiment, micellar casein, whey protein and hydrolysed whey protein are the sole protein components of the composition.

Preferably, a composition for use according to the invention, and a composition used in the methods according to the invention, comprises, in addition to the micellar casein and hydrolysed whey as major or sole protein components, one or more free amino acids and/or metabolites thereof. In one embodiment, the amino acid is one or more of the three essential branched-chain amino acids (BCAA; leucine, valine, and isoleucine), or a metabolite thereof. In a preferred embodiment, a hydrolysed whey protein is used that is enriched in leucine. For example, the hydrolysed whey protein for use in the present invention comprises at least 12% leucine, preferably at least 14%, more preferably at least 15% leucine. Alternatively, it is enriched with free leucine and/or leucine metabolites.

The use of leucine and/or a leucine metabolite is particularly preferred. For example, the composition comprises a leucine metabolite, preferably beta-hydroxy-beta-methylbutyrate (HMB). Such compositions are particularly suitable for use in a method to overcome anabolic resistance. In one embodiment, the composition comprises from about 0.1% to about 8% by weight of HMB. In a specific aspect, the composition comprises 0.2-2 g HMB per serving. Highly suitable for use in a composition comprising micellar casein and hydrolysed whey is the free-acid form of HMB, which can reach higher plasma concentrations in a shorter amount of time compared to the calcium-salt form.

The nutritional composition may but does not need to comprise fat and/or carbohydrate. In one embodiment the composition further comprises fat, and in another embodiment the composition further comprises carbohydrate. In yet another embodiment the composition further comprises fat and carbohydrate. Fat and carbohydrate suitable for use in the nutritional composition according to the invention are described in more detail below.

The carbohydrate, if present, preferably provides 5 to 50% of the total energy content of the composition, and the fat, if present, preferably provides 5 to 50% of the total energy content of the composition.

### Carbohydrate

The carbohydrate may be provided by a single source, or by more than one source of carbohydrate. The carbohydrate may be a simple or a complex carbohydrate, or a mixture thereof. Carbohydrates suitable for use in a nutritional composition of the present invention are known to the person skilled in the art. Examples of suitable carbohydrates are described in more detail in for example WO 2013/025104, WO 2014/099795 and WO 2009/072885.

### Fat

The fat may be an animal fat or a vegetable fat, or a combination thereof. Preferably the fat, if present, is of vegetable origin. Suitable fats are known to the person skilled in the art, and described in more detail in for example WO 2013/025104, WO 2014/099795 and WO 2009/072885. Non-limiting examples of sources of fat that are suitable for use in the nutritional composition include milk fat or milk fat fractions, food grade coconut oil, fractionated coconut oil, soy oil, corn oil, olive oil, rapeseed oil, safflower oil, high oleic safflower oil, MCT oil (medium chain triglycerides), sunflower oil, high oleic sunflower oil, palm and palm kernel oils, palm olein, canola oil, marine oils (e.g. fish oil), cottonseed oils, long-chain polyunsaturated fatty acids such as arachidonic acid (ARA), docosahexaenoic acid (DHA) and eicosapentaenoic acid (EPA), and combinations thereof. The nutritional composition may also comprise one or more structured lipids. Structured lipids are predominantly triacylglycerols containing mixtures of medium and long chain fatty acids on the same glycerol backbone. Structured lipids are known in the art, and described in e.g. U.S. Pat. Nos. 4,871,768, 6,160,007 and in Fitch Haumann, “Structured lipids allow fat tailoring”, INFORM, 1997, 8(10), 1004.

### Chelating Agent

In a preferred embodiment, the nutritional composition for use according to the invention, or the composition used in the methods according to the invention, comprises a chelating agent. The chelating agent is preferably selected from the group consisting of phosphoric acid, citric acid, a soluble phosphate salt, a soluble citrate salt, and a mixture thereof. Examples of soluble citrate salts include sodium citrate and potassium citrate. Examples of soluble phosphate salts include sodium phosphate, potassium phosphate, disodium hydrogen phosphate and dipotassium hydrogen phosphate. Preferably the chelating agent is citric acid or a soluble citrate salt, or a combination thereof. In this embodiment it is further preferred that the chelating agent is present in an amount of 0.5-10 g per 1000 ml of the nutritional composition. More preferably, the chelating agent is present in an amount of 0.5-8 g, even more preferably in an amount of 0.5-5 g, per 1000 ml of the nutritional composition.

As is known in the art, the presence of chelating agents may result in an alteration of the micelle structure of micellar casein. It is thought that binding of calcium to the chelating agent may result in the release of calcium ions from casein micelles. This release of calcium ions from casein micelles results in an alteration of micelle structure: the micelle volume increases, resulting in an increase of viscosity. Furthermore, precipitation of calcium salts, e.g. in the form of calcium citrate, should be prevented as this may result in less desirable organoleptic properties of the nutritional composition. The optimum amount of chelating agent will depend on, inter alia, the pH of the nutritional composition, the amount of micellar casein present in the nutritional composition, the source of the micellar casein (e.g. MCI, MPC or MPI), the amount and type of hydrolysed whey protein present in the composition and the presence of any additional optional components.

### Additional Ingredients

The nutritional composition for use and the nutritional composition used in the methods as herein disclosed may optionally comprise one or more additional ingredients selected from the group consisting of non-digestible carbohydrates, vitamins and related nutrients, and minerals.

The nutritional composition may comprise non-digestible carbohydrates. Non-digestible carbohydrates, also referred to as dietary fibers or as non-digestible oligosaccharides, are known in the art and are described in more detail in e.g. WO 2013/025104, WO 2014/099795 and WO 2009/072885, and in e.g. review articles Mussatto et al., “Non-digestible oligosaccharides: a review”, Carbohydrate Polymers 2007, 68, 587-597 and van Loo et al., “Functional food properties of non-digestible oligosaccharides: a consensus report from the ENDO project (DGXII AIRII-CT94-1095)”, British Journal of Nutrition (1999), 81, 121-132.

Non-limiting examples of non-digestible carbohydrate include fructo-oligosaccharide (FOS), galacto-oligosaccharide (GOS), trans-galacto-oligosaccharide (TOS), xylo-oligosaccharide (XOS), soy oligosaccharides, pectin, etc, preferably having a degree of polymerisation in the range of 2 to 20, more preferably in the range of 2 to 10.

The nutritional composition may comprise one or more vitamins or related nutrients. Non-limiting examples of vitamins and related nutrients include vitamin A, vitamin D, vitamin E, vitamin K, thiamine, riboflavin, pyridoxine, vitamin B, niacin, folic acid, pantothenic acid, biotin, vitamin C, choline, carnitine, inositol, salts and derivatives thereof, and combinations thereof.

The nutritional composition may further comprise one or more minerals, non-limiting examples of which include calcium, phosphorus, magnesium, iron, zinc, chromium, manganese, molybdenum, selenium, copper, iodine, sodium, potassium, chloride, and combinations thereof.

In a preferred embodiment, a composition for use or a composition used in the methods according to the invention comprises one or more micronutrients selected from the group consisting of vitamins, preferably vitamin D, vitamin B1, vitamin B2, vitamin B12 and/or vitamin K, and minerals, preferably calcium, magnesium, phosphorus and/or selenium.

The nutritional composition may further comprise one or more ingredients such as for example preservatives, antioxidants, emulsifying agents, buffers, colorants, flavors, etc. Examples of stabilizers include carrageenan and carboxymethyl cellulose (CMC).

### Viscosity

It has been found that the liquid nutritional composition for use according to the invention, or the liquid nutritional composition used in the methods according to the invention, has a surprisingly low viscosity, even after heat-treatment.

In general, increasing the amount of protein in a liquid nutritional composition results in an increased viscosity of the composition. The increase in viscosity may even be larger when the composition comprises additional components, in particular fat and carbohydrate. As described in more detail above, too high a viscosity may result in problems consuming or administering the liquid composition. Furthermore, liquid nutritional compositions having a high content of proteins typically have a decreased heat-stability.

The liquid nutritional composition for use according to the present invention, or the liquid nutritional composition used in the methods according to the invention, comprising a relatively high amount of protein and having a relatively high caloric density, has a viscosity that is acceptable for enteral administration, including by tube feeding. Preferably the composition according to the invention has a viscosity of 150 mPa s or lower, at 20° C. and at a shear rate of 100 s-1. It is further preferred that the composition has a viscosity of 120 mPa s or lower, more preferably of 100 mPa s or lower, even more preferably of 80 mPa s or lower and most preferably of 60 mPa s or lower, all at 20° C. and at a shear rate of 100 s 1. Furthermore, the viscosity of the composition is preferably 5 mPa s or higher, more preferably 10 mPa s or higher, both at a shear rate of 100 s-1. Methods to determine the viscosity of nutritional compositions are known to the person skilled in the art. The viscosity of the nutritional composition for use according to the invention, or used in the methods according to the invention, may suitably be determined by using a rotational viscometer using a cup and bob geometry.

The nutritional composition preferably has a pH in the range of 6 to 8, more preferably in the range of 6.2 to 7.5 and most preferably in the range of 6.4 to 7.2. If necessary, the pH may be adjusted by the addition of acid or base. Methods to adjust the pH of a nutritional composition are known in the art. For an increase in pH e.g. NaOH or KOH may be used. Alternatively, if the pH needs to be lowered, pH adjustment may take place with a food grade acid e.g. hydrochloric acid, citric acid, lactic acid, phosphoric acid, etc.

The liquid nutritional composition as herein disclosed has several advantages. Firstly, the presence of a protein fraction comprising at least 40 wt. % of micellar casein and at least 10 wt. % of hydrolysed whey protein, enables the liquid nutritional composition to have a relatively high protein content, such as a protein content at least 10 g per 100 ml of the composition, whereas the composition still has a low viscosity. Furthermore, the composition is able to withstand high temperature treatment such as sterilisation or UHT. In addition, the composition has a good shelf-stability. In general, the viscosity of a liquid composition comprising a relatively high amount of casein, or a combination of micellar casein and caseinate, increases over time. Surprisingly, this increase in viscosity over time is less significant in the liquid nutritional composition according to the invention comprising a combination of micellar casein and hydrolysed whey protein, in particular at lower temperature, e.g. 5° C. As is known in the art, the presence of hydrolysed protein in a nutritional composition generally results in a rather bad taste of the composition. However, in spite of the presence of hydrolysed whey protein, the liquid nutritional composition according to the invention still has a good taste.

A nutritional composition for use according to the invention, or the nutritional composition used in the methods according to the invention, including the protein blend of micellar casein and hydrolysed whey, can be manufactured as described for example in WO2016/174651.

### BRIEF DESCRIPTION OF THE DRAWINGS

FIG. 1. pH profile of the gastric simulation model over time.

FIG. 2. Percentage of protein in liquid phase over time in the stomach phase of digestion. For details see Example 1.

FIG. 3. Percentage of protein in liquid phase over time in the stomach phase of digestion. For details see Example 2.

### EXPERIMENTAL SECTION

### Materials and Methods

Protein digestion data were obtained using an established in vitro digestion stomach model. Gastric emptying is the rate limiting step in digestion. Given that the transit time of liquids through the stomach is much faster than that of (semi)solids, the amount of protein in the—fast emptying—liquid fraction (or liquid phase) is key for a fast digestion.

### Protein Sources Used:

Refit MCI 88 is a source of micellar casein, comprising 88 wt. % of protein, based on total dry matter, and about 90-95 wt. % of micellar casein protein and about 5-10 wt. % whey protein, based on protein dry matter.

Hyvital Whey 8016 is a mildly hydrolysed whey protein from fresh milk whey, having a protein content of about 80 wt. % based on total dry matter. Hyvital Whey 8016 has a degree of hydrolysis (DH) in the range of 7-10%. Hyvital Whey EtD 120 is a mildly hydrolyzed whey protein, which typically contains about 77% protein. The product is derived from fresh milk or alternatively from acid whey. Hyvital Whey EtD120 has a DH of about 8%.

Excellion Sodium Caseinate (NaCas) is a casein based protein obtained from fresh milk by acid precipitation. The product contains about 90% protein.

NutriWhey 800F (WPC80) is a whey protein concentrate with about 80% protein, obtained by ultrafiltration of acid whey.

In order to determine the amount of protein in the liquid phase, first, a test composition (depending on protein concentration of test product e.g. volume of 100 or 350 ml) is heated in the fermenter to 37° C. under continuous stirring at 50 rpm and a reference sample is taken (x.0). Subsequently, a simulated gastric fluid (350 mL) is added to the product in the fermenter, as described in Minekus Food Funct., 2014, 5:1113, consisting of:
243.2 mL of SGF electrolyte stock solution
60.8 mL porcine pepsin stock solution of 25,000 U/mL made up in SGF electrolyte stock solution (pepsin from porcine gastric mucosa, 3,200-4,500 U/mg protein, Sigma);
190 μL of 0.3 M CaCl2;
1900 μL of 1 M HCl to reach pH 3.0;
73.9 mL of water.

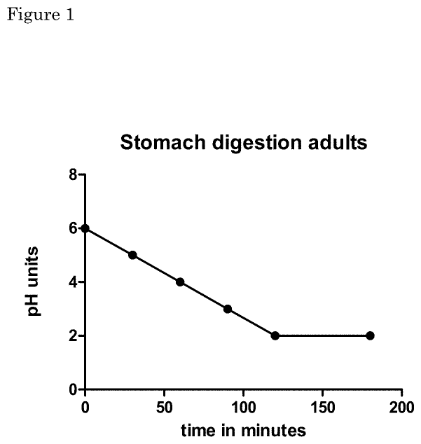

A first sample (x.1) is immediately taken as a reference and subsequently a pH is being profiled (a declining curve over time is established with HCl and NaOH, slope for all the samples similar as shown in FIG. 1).

The incubation is maintained for e.g. 1 to 3 hours at 37° C.

During digestion, samples (1*40 ml per sampling point) are taken for analysis during the test series. Pictures of the fermenter are taken at the same time the 40 ml samples are taken and samples are filtered on a gauze (mesh size 1 to 2 mm) immediately. Observations are written down in a logbook.

The sample filtrate is immediately cooled on ice to stop enzyme activity and subsequently divided for different analyses:
1.0 ml for protein analysis with LC-MS: flashfrozen immediately after filtration and stored at −20° C. till analysis.
2*12 ml for further analyses: immediately flashfrozen and stored at −20° C. till analysis.
Rest sample for protein analysis

### Example 1

In this Example, the digestibility was assessed for compositions comprising a blend of micellar casein and a hydrolysed whey protein (test composition A), a blend of micellar casein and sodium caseinate (test composition B) and for a composition comprising native whey (test composition C).

Protein analysis (Table 1) of the test compositions revealed the following:

A: 10% MCI with whey hydrolysate: 10 g protein per 100 ml in a 67:33 weight ratio.

B: 10% MCI with sodium caseinate: 10 g protein per 100 ml in a 67:33 weight ratio.

C: 10% Whey protein: 10 g protein per 100 ml.

TABLE 1
Results of the protein analyses (Kjeldahl)

| | A | B | C |
|---|---|---|---|
| Time (min) | MCI88:HWP8016 | MCI88:NaCas | WPC80 |
| 0 | 10.09 | 10.39 | 10.1 |
| 0 | 2.71 | 2.69 | 2.66 |
| 15 | 2.69 | 1.17 | 2.66 |
| 30 | 2.65 | 1.24 | 2.66 |
| 45 | 2.60 | 1.48 | 2.64 |
| 60 | 2.55 | 1.67 | 2.62 |
| 90 | 2.50 | 1.97 | 2.58 |
| 120 | 2.46 | 2.45 | 2.50 |

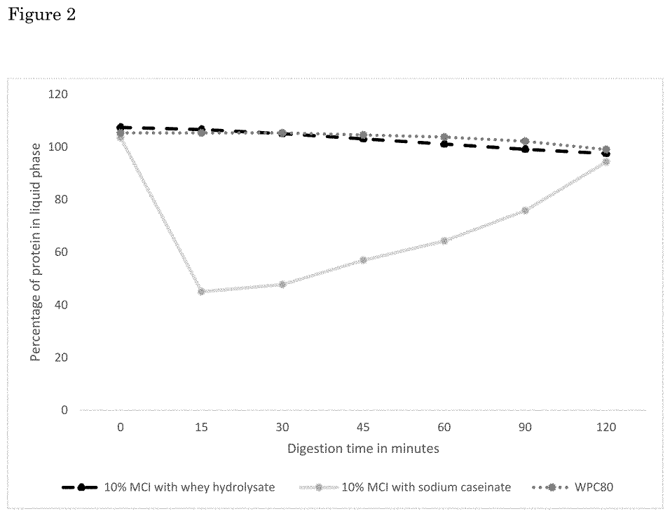

As is demonstrated in Table 1 and FIG. 2, a blend of MCI and hydrolysed whey protein (Composition A, MCI:HWP 8016) stays in a liquid phase under pH stomach conditions in adults, which is in marked contrast to the lumping observed for the MCI:NaCas blend (Composition B). Since protein in the liquid phase is likely to leave the stomach faster, digestion of the MCI:HWP protein blend is faster than that of the MCI:NaCas blend, which gels or coagulates in the stomach and therefore results in delayed gastric emptying and digestion.

Even more surprisingly, the gastric emptying of a MCI:HWP composition of the invention was comparable to that of whey protein, as shown by the WPC80 reference sample in FIG. 2 (Composition C).

### Example 2

In this experiment, the digestibility was assessed for compositions comprising a blend of micellar casein and different hydrolysed whey protein (test compositions E and F). Also, the relevance of the whey being hydrolyzed in these test products was investigated with reference composition G comprising native whey. In reference composition H, the weight ratio of micellar casein to hydrolysed whey protein is 95:5, and thus outside the claimed range of 90:10.

The following test compositions were prepared:

E: MCI88:HWP EtD120: 10 g protein per 100 ml in a 67:33 weight ratio

F: MCI88:HWP 8016: 10 g protein per 100 ml in a 67:33 weight ratio (same proteins and ratio as in test product B in experiment 1) G: MCI88:WPC80: 10 g protein per 100 ml in a weight ratio of 80:20 (as in bovine milk)

H: MCI88:8016: 10 g protein per 100 ml in a weight ratio of about 95:5

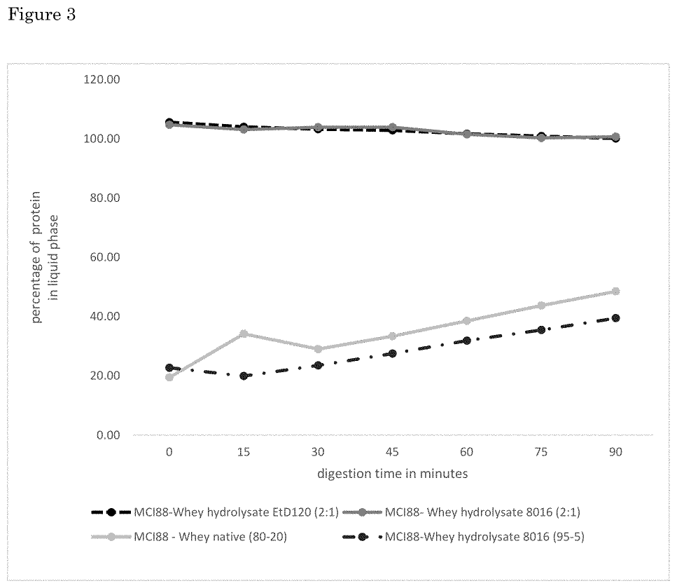

The results in Table 2 and FIG. 3 demonstrate that, in agreement with the data shown above in Table 1, the protein in the test compositions with MCI:HWP 8016 (F) and MCI:HWP EtD120 (E) stays in a liquid phase under pH stomach conditions in adults (as shown in experiment 1). In contrast, protein in a composition comprising MCI88: WPC80 in a 80:20 weight ratio (G), i.e. lacking hydrolysed whey protein and similar to the ratio in bovine milk, was largely depleted (60-80%) from the liquid phase. This is indicative of a delayed gastric emptying. The same holds true for a blend comprising 95 wt % MCI88 and 5 wt % hydrolysed whey protein (H).

TABLE 2
Results of protein analysis (Kjeldahl)

| Time | E | F | G | H |
|---|---|---|---|---|
| (min) | MCI88:HWPEtD120 | MCI88:HWP8016 | MCI88:WPC80 | MCI88:HWP8016 |
| 0 | 10.3 | 10.0 | 10.13 | 10.1 |
| 0 | 2.70 | 2.60 | 0.49 | 0.57 |
| 15 | 2.66 | 2.56 | 0.86 | 0.50 |
| 30 | 2.64 | 2.58 | 0.73 | 0.59 |
| 45 | 2.63 | 2.58 | 0.84 | 0.69 |
| 60 | 2.60 | 2.52 | 0.97 | 0.80 |
| 75 | 2.58 | 2.49 | 1.10 | 0.89 |
| 90 | 2.56 | 2.50 | 1.22 | 0.99 |

1. A method of (a) preventing or reducing coagulation in the upper gastro-intestinal tract; (b) increasing the rate of gastric emptying; (c) enhancing protein digestion; (d) increasing the blood serum concentration of free essential amino acids in a subject in a disease state, recovering from a disease state, and/or malnourished, the method comprising administering to the subject a heat-treated liquid high-protein composition comprising at least 10 g of protein per 100 ml of the composition, comprising:
(i) at least 40 wt. % of the protein as micellar casein; and
(ii) at least 10 wt. % of the protein as hydrolysed whey protein having a degree of hydrolysation of at least 5%, and
wherein the weight ratio of micellar casein to hydrolysed whey protein is in the range of 40:60 to 90:10.

2. The method according to claim 1, wherein the subject suffers from a decline of lean muscle mass, muscle wasting, muscle decline, bone decline, sarcopenia, osteoporosis and/or osteosarcopenia.

3. The method according to claim 1, wherein micellar casein and hydrolysed whey protein are present in the composition in a combined amount of at least 70 wt % of the total protein.

4. The method according to claim 1, wherein the protein provides 20% to 95% of the total energy content of the composition.

5. The method according to claim 4, wherein the protein provides 50% to 80% of the total energy content of the composition.

6. The method according to claim 1, wherein the composition comprises at least 12 g protein per 100 ml of the composition.

7. The method according to claim 1, wherein the composition has a unit serving size comprising at least 12 g of protein.

8. The method according to claim 1, wherein the composition has a unit serving size of up to 125 ml.

9. The method according to claim 1, wherein at least 50 wt. % of the protein is micellar casein and/or at least 15 wt. % of the protein is hydrolysed whey protein.

10. The method according to claim 1, wherein the weight ratio of micellar casein to hydrolysed whey protein is in the range of 60:40 to 90:10.

11. The method according to claim 1, wherein the hydrolysed whey protein has a degree of hydrolysation in the range of 5 to 25%.

12. The method according to claim 1, wherein the viscosity of the composition is 150 mPa·s or lower, at 20° C. and at a shear rate of 100 s⁻¹.

13. The method according to claim 1, wherein the composition has an energy density of 1.5 kcal/ml or higher.

14. The method according to claim 1, wherein the composition further comprises vitamins and/or minerals.

15. The method according to claim 13, wherein the vitamins are selected from the group consisting of vitamin D, vitamin B1, vitamin B2, vitamin B12 and vitamin K.

16. The method according to claim 1, wherein the minerals are selected from the group consisting of calcium, magnesium, phosphorus and selenium.

17. The method according to claim 1, wherein the composition further comprises a leucine metabolite.

18. The method according to claim 16, wherein the leucine metabolite is beta-hydroxy-beta-methylbutyrate (HMB).

19. The method according to claim 1, wherein the composition increases the blood serum concentration of essential amino acids to overcome anabolic resistance in a subject, preferably an elderly subject.

20. The method according to claim 1, wherein the composition increases the blood serum concentration of leucine in a subject to higher than 250 micromol/L, preferably higher than 300 micromol/L within about 60 minutes after administration.

21. A method of treatment and/or prevention of a condition linked to a loss of muscle mass and/or strength in a subject in a disease state, recovering from a disease state, and/or malnourished, the method comprising administering to the subject a heat-treated liquid high-protein composition comprising at least 10 g of protein per 100 ml of the composition, comprising:
(i) at least 40 wt. % of the protein as micellar casein; and
(ii) at least 10 wt. % of the protein as hydrolysed whey protein having a degree of hydrolysation of at least 5%, and
wherein the weight ratio of micellar casein to hydrolysed whey protein is in the range of 40:60 to 90:10.

22. A heat-treated liquid nutritional composition in a unit serving size of up to 100 ml, having at least 40 wt. % of protein being micellar casein and at least 10 wt. % of being hydrolysed whey protein having a degree of hydrolysation of at least 5%, wherein the ratio of micellar casein to hydrolysed whey protein is in the range of 40:60 to 90:10, and wherein the composition comprises at least 15 g of protein.
